(19) United States
(12) Patent Application Publication
(10) Pub. No.: US 2011/0276376 A1
(43) Pub. Date: Nov. 10, 2011

(54) SYSTEMS AND METHODS FOR PROVIDING MULTIPLE INCENTIVES FOR JOB REFERRALS

(76) Inventor: Steven J. Schmitt, Pittsburgh, PA (US)

(21) Appl. No.: 13/100,641

(22) Filed: May 4, 2011

Related U.S. Application Data
(60) Provisional application No. 61/331,371, filed on May 4, 2010.

(51) Int. Cl. G06Q 30/00

(52) U.S. Cl. 705/14.16

(57) ABSTRACT

Systems and methods as described herein provide for a professional talent management platform and associated interfaces. Embodiments provide for registering one platform members, listing open positions, accepting referrals for the positions from the platform members, and providing incentive rewards to the members for qualified referrals and/or other qualifying platform interactions.

### CROSS REFERENCE TO RELATED APPLICATION

This application claims the benefit of U.S. Provisional Patent Application Ser. No. 61/331,371, entitled “Systems and Methods for Multi-Level Professional Referral Social Networking,” filed on May 4, 2010, the contents of which are incorporated by reference as if fully set forth herein.

### FIELD OF THE INVENTION

The subject matter presented herein generally relates to Internet-based talent management in relation to professional recruitment and candidate referrals, including providing multiple incentive rewards for candidate referrals, and systems and methods therefor.

### BACKGROUND

Employers currently have a limited number of resources for locating candidates for open positions. Typical methods include print advertising and partnering with staffing and recruitment agencies. More recently, a first wave of web sites established the feasibility of utilizing the Internet to post employment positions and search for potential candidates, for example, through online job boards. Among these web sites are resume posting and job search sites, such as MONSTER.COM®. MONSTER.COM is a registered trademark of TMP Worldwide Inc. in the United States and other countries. Although the Internet is now considered a vital job placement resource, online job boards and recruitment sites have long been losing their effectiveness, especially in high demand industries such as information technology and healthcare, and have not adapted to fully realize the potential of recent technological advances.

### BRIEF SUMMARY

In summary, one aspect of the invention provides a system comprising: one or more processors; a system memory operatively coupled to the one or more processors; and one or more professional talent management modules communicatively coupled to the system memory, wherein the one or more professional talent management modules are adapted to: register one or more members; list one or more positions; accept one or more referrals for the one or more positions from the one or more members; and provide one or more incentive rewards from a plurality of incentive reward sources to the one or more members, wherein the incentive reward source is selected according to one or more member interactions.

In summary, another aspect of the invention provides a method comprising: registering one or more members; listing one or more positions; accepting one or more referrals for the one or more positions from the one or more members; and providing one or more incentive rewards from a plurality of incentive reward sources to the one or more members, wherein the incentive reward source is selected according to one or more member interactions.

In summary, one aspect of the invention provides a computer program product comprising: a computer readable storage medium having computer readable program code embodied therewith, the computer readable program code comprising: computer readable program code configured to register one or more members; computer readable program code configured to list one or more positions; computer readable program code configured to accept one or more referrals for the one or more positions from the one or more members; and computer readable program code configured to provide one or more incentive rewards from a plurality of incentive reward sources to the one or more members, wherein the incentive reward source is selected according to one or more member interactions.

### BRIEF DESCRIPTION OF THE SEVERAL VIEWS OF THE DRAWINGS

FIG. 1 provides an example talent management platform interface according to an embodiment.

FIG. 2 provides an example member network for according to an embodiment.

FIG. 3 provides an example multi-level member network according to an embodiment.

FIG. 4 provides an example member network according to one embodiment.

FIG. 5 provides an example of incentive reward levels according to an embodiment.

FIG. 6 provides an example of an affinity incentive reward according to an embodiment.

FIG. 7 illustrates an example computer system.

### DETAILED DESCRIPTION

It will be readily understood that components of the embodiments, as generally described and illustrated in the figures herein, may be arranged and designed in a wide variety of different configurations in addition to the described example embodiments. Thus, the following more detailed description of embodiments, as represented in the figures, is not intended to limit the scope of the invention, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that various embodiments can be practiced without one or more of the specific details, or with other methods, components, materials, et cetera. In other instances, well-known structures, materials, or operations are not shown or described in detail to avoid obfuscation. Throughout this description, example embodiments may be described in connection with a computer, such as a desktop, laptop, or notebook computer; however, those skilled in the art will recognize that certain embodiments are equally applicable to other types of electronic devices.

A successful organization today must recruit and retain the best talent to remain competitive. However, there is little alternative but to rely on inefficient conventional methods, such as print advertising and online job boards, or to partner with firms in the professional staffing industry that depend on inefficient tools, technologies, and processes. These firms include staffing, recruiting, headhunting, and consulting firms. Although these professional staffing firms are able to provide some assistance to employers, research suggests they have ultimately created an environment that lacks certain necessary characteristics, such as efficiency, trust, reliability, and accountability.

While endeavoring to recruit and retain talent, human resource (HR) departments are also being faced with several other critical issues, including a massive shortage of skilled professionals, a hyper-competitive business climate, a complicated global workforce, and the increased specialization of labor. These issues are exacerbated in industries where demand for qualified professionals significantly exceeds supply, such as information technology, healthcare, and energy. Accordingly, employers and HR managers, who are often under enormous pressure to attract talent, are seeking innovative, trustworthy, and effective ways to connect with qualified candidates and to maintain current operations in sync with their organization's efforts to fuel new growth.

Personal referrals have long been an effective source for obtaining quality candidates for job openings. Referrals are important because they create a connection between the employer and the candidate that an application from an unknown or non-recommended individual simply cannot provide. However, most employers cannot rely on referrals alone because of their personal and incidental nature.

Certain organizations have attempted to create platforms that allow individuals to refer candidates for open positions. For example, an organization may have an internal referral program wherein an employee receives some form of compensation for referring a qualified candidate for an open position or, more commonly, if the referred candidate is hired for the open position. Similarly, certain professional staffing firms may have referral systems wherein individuals outside an organization are compensated for recommending a qualified candidate who ultimately is hired for an open position. Although such methods potentially provide employers with candidate referrals for open positions, participants are typically only rewarded on a one-time basis for one specific position. As such, individuals are not motivated to continually participate and make quality referrals within such platforms. Thus, a lack of effective incentive models that both motivate participation and elicit continuous quality referrals significantly degrades the worth to potential employers of conventional referral systems.

Embodiments provide an Internet-based professional talent management platform. More specifically, embodiments provide systems for providing access to professional talent, including, but not limited to, through recruitment and referral systems. For example, embodiments provide systems and methods for the consistent generation of quality referrals to employers. Embodiments described herein are configured to assist individuals, such as hiring managers, find quality employees and/or contractors as efficiently as possible.

Embodiments implement an Internet-based approach that transforms the traditional, hierarchical staffing model into a model based on an online long-term incentive referral network. Certain embodiments are configured to use a unique business model and software to match demand for qualified employees with a supply of job seekers and passive candidates via the Internet. Certain embodiments assist in identifying increased numbers of qualified talent in a more efficient way, transforming conventional talent management approaches.

In addition, embodiments provide incentives for members and associates of the professional talent management platform to actively participate in the recruitment and referral systems. According to embodiments, the incentives may comprise one or more long-term incentives, contrary to the short-term incentives provided by existing platforms. As a non-limiting example, one embodiment provides that the incentives may consist of certain rewards allocated to platform members for referring a candidate to an open position posted on the platform. Another embodiment provides for an incentive reward wherein a platform member is awarded a percentage of the billable hours earned by a referred candidate hired for a contractual position for a specified duration of the contract. A still further embodiment provides for a financial incentive award for platform members who increase the platform network, including, but not limited to, publishing an article about the platform, increasing the number of platform members, or procuring job orders for the platform. As such, embodiments provide for at least three incentive models for eliciting active, long-term platform member participation, for example, in the platform referral and recruiting systems.

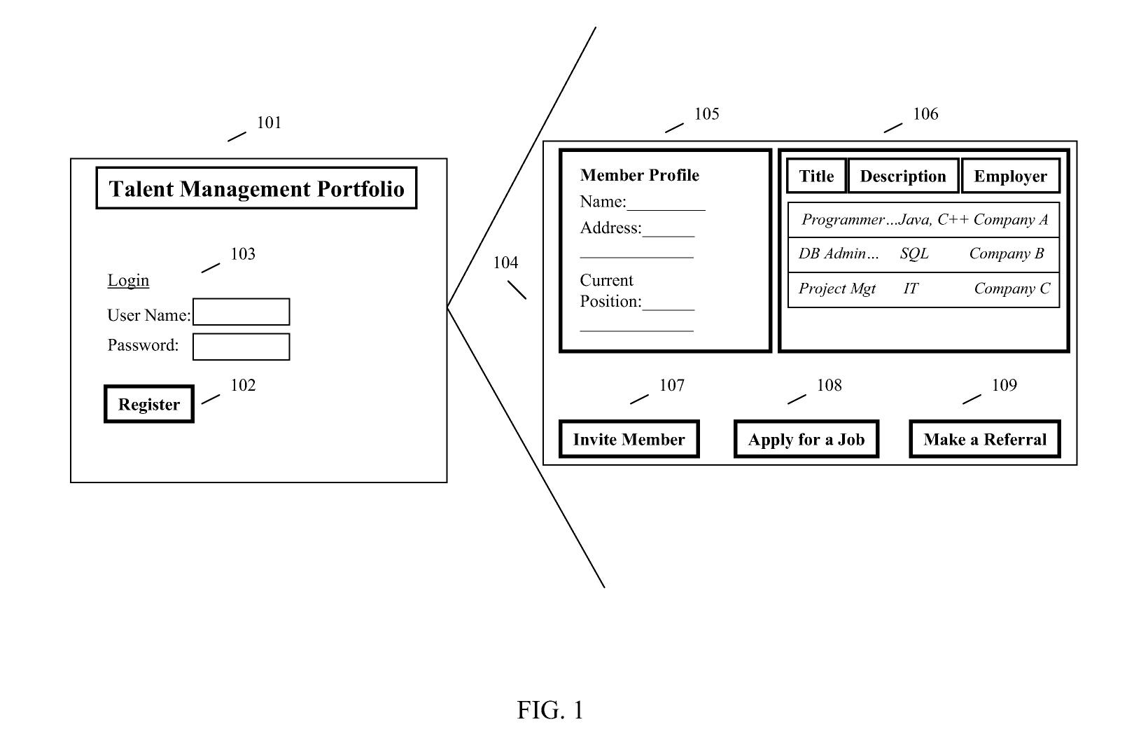

Referring to FIG. 1, therein is depicted an example talent management platform interface according to an embodiment. In the example embodiment depicted in FIG. 1, the talent management platform is implemented as an Internet-based service with an interface 101 accessible through a web browser. According to embodiments, individuals may register 102 as a new member at the platform web site. As an example member, consider an information technology professional, such as a software engineer, a network engineer, a project manager, a help desk professional, a database analyst, an ERP specialist, a web developer, a graphics designer, or a technical writer. In addition, embodiments provide that the member may take on different roles as part of his or her membership. Illustrative and non-restrictive examples of member roles include seeking full time employment, referring colleagues for open positions (jobs), and acting as a hiring manager or a consultant for one or more companies.

Registration may include choosing a member name and password, filling out a member profile (which can include for example both professional and personal information fields), and saving the membership information. In at least one embodiment, becoming a member and maintaining a membership will not require a fee. In another embodiment, a member may register using credentials from a social networking service, including, but not limited to, LinkedIn® or Facebook®. Facebook is a registered trademark of Facebook, Inc. LinkedIn is a registered trademark of LinkedIn Ltd.

After registering as a platform member, embodiments provide that a user may login 103 to the platform and access certain functions and services 104. For example, the functions and services may be available through a member profile or dashboard interface. As non-limiting examples, functions and services 104 may include creating and editing a member profile 105, viewing posted jobs 106, inviting members to join the platform 107, applying for a job 108, and referring a candidate for a job 109.

After a member has registered, certain embodiments provide that the talent management platform may utilize various methods to verify the member. According to embodiments, verification may be rigorous and may include one or more of the following: credit check(s), drug screening(s), verification of resume information (for example, education and employment information), and requiring direct invitation from an existing member.

Certain embodiments are configured to track a large amount of information regarding members. Such information may include, but is not limited to, social networking site information, including profile and connection information; information resulting from background checks, credit checks, and/or drug screenings; customer ratings; basic demographics; resume information; and member invitation, platform promotional, and job listing procurement information. Such information may be gathered and organized by certain embodiments to form a repository of information regarding a particular member or members. In addition, embodiments may be configured to require such information of the members and that some or all of the information be made accessible, for example, in an effort to create an exclusive set of members, as reflected by the information gathered and made available regarding the members.

Embodiments provide for talent management platform function interfaces that may be accessed from within the talent management platform interface. For example, a community-based user interface modality may be available according to embodiments, which integrates social networking sites, communications modalities (e.g., email and instant messaging), a jobs posting service, as well as various other web 2.0 capabilities. A credibility score interface may include, but is not limited to, a member rating system, a system providing periodic to continuous feedback for members, and a validity checking system that may conduct and display results relating to various checks, such as credit and criminal background checks. In addition, embodiments provide for one or more interfaces that may include a reserving capability, a recruiting capability, or a retaining capability for members conducting recruiting services. Certain embodiments may further provide a growth interface according to an embodiment that includes, for example, an incentive plan and tracking thereof, a dashboard for hosting widgets, and accounting capabilities.

Embodiments provide for a talent management platform user interface wherein a member may access multiple aspects of the platform from a unified interface. As a non-limiting example, the member may access the interface and view a list of connections, which may comprise platform network connections or external network connections (e.g., social network connections), and associated information. For each connection, a list of jobs wherein the connection may be a quality referral may be listed along with information related to each listed job. As such, a user may view all of his connections and all available jobs where the connection may be a quality referral from a common interface. According to embodiments, the member may select to view all of the available jobs and the interface would display potential referrals derived from the member's connections. In addition, embodiments provide that the member may be able to use the interface to view all available jobs, for example, ranked by how well they fit the member's profile and qualifications.

Embodiments are configured to provide members with opportunities including but not limited to contract assignments, full time jobs, projects, and freelance opportunities. Certain embodiments are configured to reward members for certain services, such as referring another member successfully or building a network from which a qualifying referral is received. According to embodiments, rewards may take various forms, including, but not limited to, increased member ranking, financial or other forms of remuneration, charitable donations, advanced access to job postings, enhanced referral abilities, or some combination thereof. In addition, embodiments are configured to make automated attribution of rewards to members. For example, a member may link a payment account to, or establish an in-house account with, the platform system and receive regular (for example, monthly) distributions of rewards (for example, payments/account deposits) for his or her qualifying events. Furthermore, certain other embodiments provide that members may designate one or more charitable endeavors to receive earned rewards.

Each member may have a network according to embodiments. For example, embodiments provide that a user may invite members to join his or her network, while other embodiments may leverage social networking web sites to assist members in building a network, as by leveraging a member's existing contacts from other social networking sites as a starting point for identifying candidates for referral. According to embodiments, if a user registers using social networking credentials, the talent management platform may obtain available social network information, including the profile information of the user's social network contacts. As such, certain embodiments are configured to interface the talent management platform with various other social networking web sites and other web sites to facilitate information retrieval and importation from these other web sites, such as contacts lists, member characteristics, or organization characteristics. The member's network may, for example, comprise a referral network, such that a member may receive a reward when any one in his or her network receives a reward.

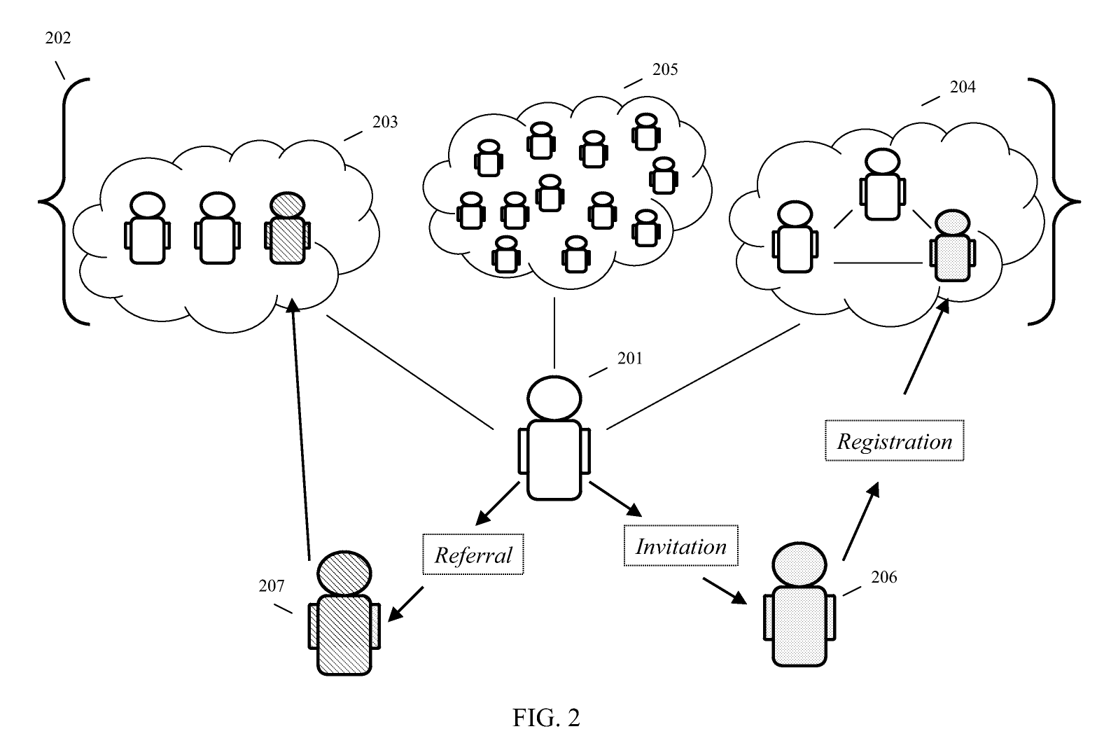

Referring to FIG. 2, therein is depicted an example member network according to an embodiment. A talent management platform member, Member 1 201 may have a network 202 consisting of connections, including, but not limited to, referral connections 203, member connections 204, and outside network connections 205.

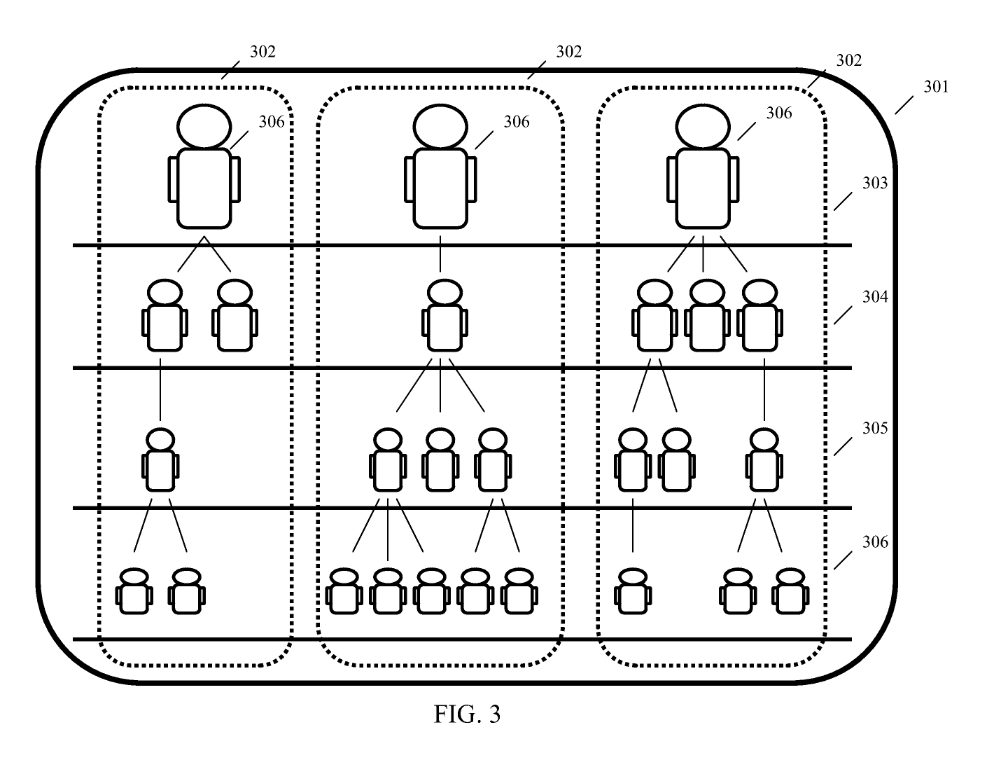

According to embodiments, member connections 204 may consist of platform members in Member 1's 201 network 202. For example, if Member 1 201 invites Member 2 206 to join the talent management platform and Member 2 206 registers with the platform, Member 2 206 is in Member 1's 201 network 202, more specifically, as a member connection 204. In addition, platform members who register responsive to invitations from members in Member 1's 201 network 202 become a part of Member 1's 201 network 202, for a certain number of levels. FIG. 3, discussed below, provides more detail regarding different member connection levels. Embodiments provide for the automated handling of invitations, for example, by a member executing an invitation function from the talent management platform interface and providing certain information regarding the invited individual, such as the individual's email address. The invitee subsequently may respond to the request and register as a member of the platform.

Embodiments provide that referral connections 203 may be comprised of platform referrals related to Member 1 201, such as referrals made directly by Member 1 or referrals made by members of Member 1's 201 network 202 (i.e., member connections 204) for a certain number of levels. In a non-limiting example provided in FIG. 2, Member 1 201 refers Candidate 1 207 for a position and, in response, Candidate 1 207 becomes linked to Member 1 201 as a referral made by Member 1 201 within the platform. Furthermore, embodiments provide that a member's network may consist of outside network connections 205, such as social networks the member has joined. For example, if Member 1 201 is a member of LinkedIn®, Member 1's 201 LinkedIn® accessible network of connections may be accessed as outside network connections 205 in Member 1's 201 network 202.

Embodiments are not limited to the types, number, and form of the networks 202-205 described in FIG. 2, as this figure depicts one non-restrictive embodiment and the networks provided therein are for illustrative purposes. According to embodiments, many different networks and sub-networks may be provided in multiple potential configurations. In addition, embodiments provide that there may be overlap between the different networks. As an illustrative and non-restrictive example, Member 1 201 may invite a member from his outside network connections 205, if the invitee accepts the invitation, then the invitee will become a member connection 204 of Member 1 201. Thus, the invitee will belong to Member 1's 201 outside network connections 205 and his member connections 204. Furthermore, if Member 1 201, then refers the invitee to a position within the platform, the invitee will additionally belong to Member 1's referral network 203.

Embodiments provide for a multi-level or multi-tiered network. In a non-limiting example, a member network may be comprised of four levels, with the member himself occupying the first level. According to embodiments, if a first member directly interacts with a second member, the second member may become a member of the first member's network at the second level (the first level below the member himself). Non-limiting examples of interaction include inviting a member to join the network or referring an individual for a position. In addition, when a member in the first member's second level directly interacts with a third member, the third member may become a member of the first member's third level (and a member of the second member's second level). Embodiments provide that the addition of connections within a member network may be added accordingly, including to more remote levels.

Referring to FIG. 3, therein is depicted an example multi-level member network according to an embodiment. The talent management platform network 301 consists of platform members each associated with a member network 302, wherein each member network may be comprised of multiple levels. In the illustrative and non-restrictive example shown in FIG. 3, the member network has four levels 303-306, although more or less levels are possible. According to embodiments, the first level 303 consists of platform members 307. The remaining levels 303-306 consist of the network connections of the members 307 and indicate the relatedness between platform members. For example, if a first member invites an invitee to join the network and the invitee registers with the network, the invitee becomes a member of the first member's network at the second level 303 (the first level below the actual member). In addition, embodiments provide for multiple types of networks (not shown), such as a public platform network and one or more private networks each associated with a private entity.

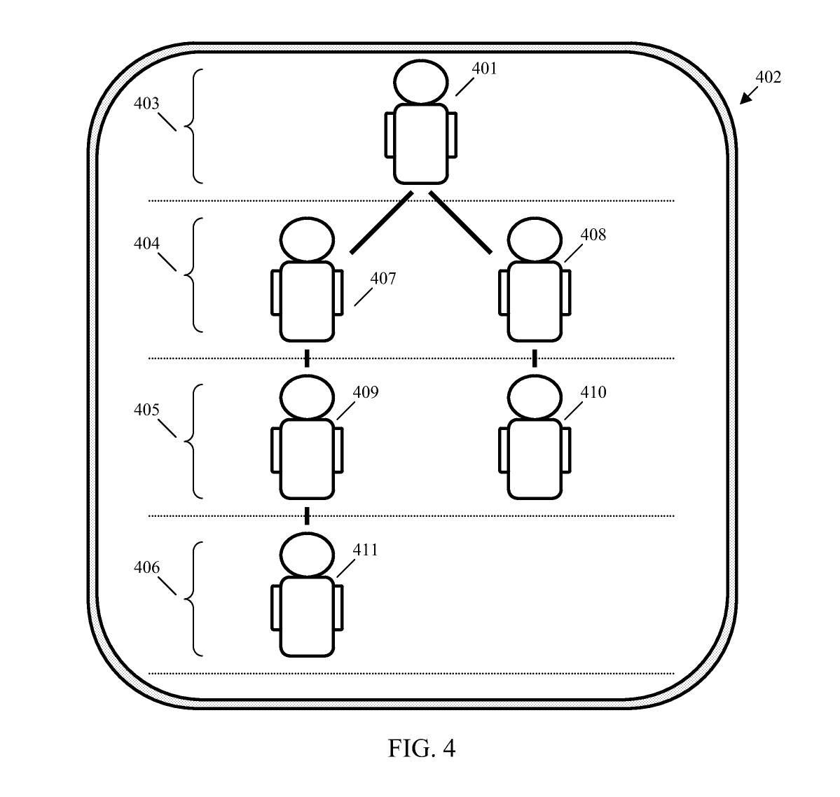

In FIG. 4, therein is provided an example member network according to one embodiment. Member 1 401 is associated with a network 402 comprised of four levels 403-406. The first level 403 consists only of Member 1 401, who may be considered the “parent” node of the network 402. The second level 404 consists of network members directly related to Member 1, such as through invitation or referral, and may be considered the “child” nodes of the network 402. A non-limiting example provides that if Member 1 401 invites Member 2 407 to join the talent management platform and Member 2 407 subsequently registers, then Member 2 407 becomes a member of Member 1's 401 network 402. Member 2 407 is in the second level 403 because Member 2 407 is directly related to Member 1 401 because Member 2 407 joined the platform responsive to an invitation from Member 1 401. In another non-limiting example, if Member 1 401 referred Member 3 408 to a position, Member 3 408 becomes connected within Member 1's 401 network 402 at the second level 403 because Member 3 408 is directly related to Member 1 401 through the referral.

The third 405 and fourth 406 levels are indirectly related to Member 1 401 through activity by members related to Member 1 401 at a higher level. A non-restrictive illustration provides that if Member 2 407 invites Member 4 409 to join the platform, when Member 4 409 registers, Member 4 409 becomes a connection in Member 1's 401 network 402 at the third level 405. Member 4 409 is indirectly related to Member 1 401 because Member 4 409 joined the network responsive to an invitation from a member related to Member 1 401 (i.e., Member 2 407). Another example provides that if Member 3 408 refers Member 5 410 for a position, Member 5 410 subsequently joins Member 1's 401 network 402 as a third level 405 member. Embodiments provide that the non-limiting example of network relationships may continue for one or more levels, such as level four 406 depicted in FIG. 3. For example, if Member 4 409 subsequently refers Member 6 411 for a position, Member 6 411 may be connected to Member 1 401 in level four 406 of the network 402.

In addition, embodiments provide that there may be overlap and/or shared connections between member networks. As a non-limiting example, Member 4 409 is a second level member of Member 2's 407 network (not shown) because Member 4 409 is directly related to Member 2 407 through Member 2's 407 invitation. In addition, Member 4 409 is also a member of Member 1's 401 network 402 at the third level 405. In addition, Member 5 410 is a second level connection in the network of Member 3 408 (not shown) and a third level 405 connection in the network 402 of Member 1 401.

Following registration and verification, embodiments provide that members may have access to job postings, which may include a frequently updated listing of job postings, such as daily updated job postings. A member, in response to reviewing the job postings, may search his or her personal network for individuals that may match the job postings. Embodiments may automate this search by automatically suggesting certain “friends” or other such individuals connected to the member that may qualify. Such automated suggesting may include, for example, comparing one or more metrics associated with the job posting to one or more metrics associated with the “friends” profiles in the member's personal network on the system (which may be imported from other web sites). Thereafter, the member may make a referral.

Certain embodiments provide systems and methods for implementing a dual incentive model for professional talent management. A member has an incentive to recruit and provide references for quality candidates because a member's reward level may depend in part on the quality of the candidates produced, as tracked over time and reported on by other members, which can include clients. For example, a member's reward (such as level of compensation) may be correlated with the member's rankings. Moreover, members may have an incentive to recruit and provide quality candidates because quality and loyalty and retention of candidates may be tracked within the system and reported on the member's profile. Similarly, members providing other services (other than recruiting) may likewise have incentive to provide quality, reliable services because metrics can similarly be employed to track these member activities over time as well.

Certain embodiments allow for better, faster and cheaper location of talent compared to prior talent management approaches, for example by leveraging member's use of social networking web sites. This is in part because, according to certain embodiments, more people will be looking for the desired talent, for example, by employing contacts from other networks, including social networking sites. Members trying to identify qualified talent will be highly motivated to do so, both because positive incentives (for example, remuneration) and negative incentives (decreased member ranking or credibility scoring) may be accrued over time. Moreover, certain embodiments provide for more passive candidates to be identified, for example by leveraging interaction with other social networking web sites, with enforced credibility for members recommending these passive candidates. Certain embodiments will reduce costs associated with talent management by virtue of having less turnover. For example, as a result of more qualified candidates being identified and recommended in the first place due to a long-term incentive approach according to embodiments.

A system according to embodiments may include one or more modules such as a candidate module, a jobs module, a rankings module, a reference/referral module, a rewards module and a communications module. The system may communicate via the communications module with one or more remote devices such as a member's client device (for example, a personal computer or cell phone), one or more other web sites hosted by remote devices (for example, servers), such as social networking sites or other web sites (for example, customer sites or industry web sites).

According to embodiments, the candidate module may be configured to store one or more lists of potential candidates, for example, members within a particular member's network of contacts or other contacts as identified from other web sites. Embodiments provide that the jobs module may be configured to store one or more jobs listings, such as listings submitted by potential employers looking for qualified professional talent. Embodiments provide that the referral/reference module may be configured to store one or more lists of contacts actually referred or referenced by a member for particular positions. According to embodiments, the credibility score module may be configured to store one or more credibility scores associated with a member's performance within the system, for example, over specific period of time or over the duration of a user's membership. Embodiments provide for a rewards module that may be configured to store accounting details, such as one or more rewards awarded to a member for past services.

Each of the modules may be configured according to embodiments to execute computer program code configured to carry out specific acts or functions associated with storing, updating, or modifying, relevant information associated with the functionality of the module. Moreover, systems consistent with embodiments may contain more or less modules than illustrated, such as two modules being consolidated and/or additional modules being added for executing functionality consistent with the systems and methods described herein. Moreover, the modules may be linked or combined in a variety of ways depending upon the particular use contemplated.

Embodiments may provide a member home page for display on a member's device, such as a personal computer, cell phone, or other computing device. The member home page may contain a variety of functional units for executing commands requesting that a system as described herein perform functions consistent with those described herein. For example, a member homepage may include, but is not limited to, providing an email client, a messaging client, an accounting client, and an invite/recruiting client. The invite/recruiting client may provide functionality supporting member recruiting activities, such as providing an option to invite a new member to join the system, invite an existing member to become part of the particular member's personal network, and conducting recruiting services such as selecting another member and referring them as a candidate for a job opening. The accounting client may provide accounting services to the member, such as linking a member account to that of a financial institution such that the rewards issued to a member can be direct deposited into the member's account at the given financial institution.

In addition, the member home page may include a variety of tabs that, in response to selection, provide a convenient display of member activities. A contacts tab may be provided that displays a list of contacts of the member upon selection. The contacts may include both member network contacts within the system as well as member contacts as derived from one or more external networks, such as social networking sites, to which the member belongs. A jobs listing tab, may include, for example, a listing of jobs deposited within the system by clients looking to fill open positions. A rewards tab may include a listing of current, past or pending rewards a member has or can obtain via activities within the system. A credibility score tab may include the member's credibility score regarding referral activities within the system. A referrals tab may include a listing of referrals the member has made. A references tab may include a list of references the member has made.

Furthermore, the member's home page may include links to other web sites, such as other social networking web sites the member belongs to or web sites dedicated to certain professional organizations. The member's home page may also include a search function such that the member may search within the system for other pages, such as pages of other members, or for posted jobs. The member's homepage according to certain embodiments may display one or more member rankings or credibility scores, viewable by other members.

Embodiments described herein provide for one or more incentive models for providing rewards to members for qualifying referrals. In addition, embodiments provide incentives configured to provide members with long-term motivation to actively participate in the talent management platform, including the continuous placement of quality referrals. For example, one embodiment provides that a member may receive a reward whenever a member of their network receives a reward.

According to embodiments the incentive rewards may be based on levels. As a non-limiting example, a member may receive a first level reward for a qualifying direct referral; a member may receive a second level reward for a qualifying indirect referral; and a member may receive a third level reward for a qualifying remotely connected referral from his or her network. According to certain embodiments, a first level reward may be of higher value than a second level reward, a second level reward may be higher than a third level reward, and so on. Referring to FIG. 4, a first level reward may involve members in the second level 404 of Member 1's 401 network 402; second level rewards may involve members in the third level 405 of the network 402; and third level rewards may involve members in the fourth level 406 of the network 402.

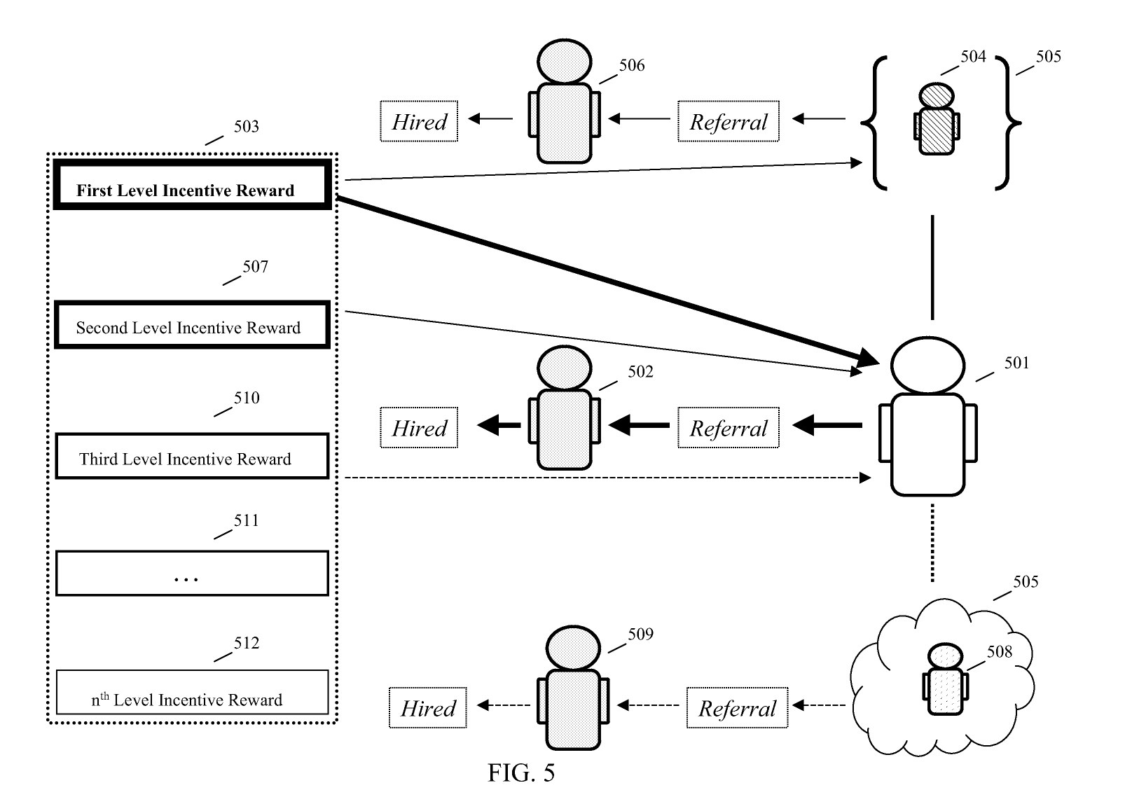

Referring to FIG. 5, therein is depicted an example of incentive reward levels according to an embodiment. A talent management platform member, Member 1, 501 recommends Candidate 1 502 for a job listing. If Candidate 1 502 is hired, then Member 1 501 may be entitled to a first level incentive reward 503 because Member 1 501 directly referred Candidate 1 502 for the first job listing. For example, if the first job listing is for long-term, non-contractual employment, the first level incentive reward 503 may consist of a one time payment, such as a fixed one time payment or a certain percentage of Candidate 1's 502 first year salary.

In FIG. 5, Member 2 504 may be a direct connection in Member 1's 501 network 505 and may refer Candidate 2 506 for a different job listing. If Candidate 2 506 is hired for the job listing, then Member 2 504 may be entitled to a first level incentive reward 503 because Member 2 504 directly referred Candidate 2 506. In addition, Member 1 501 may be entitled to a second level incentive reward 507 because Member 1 501 indirectly referred Candidate 2 506 because a member of his network, Member 2 504, made the qualifying referral.

FIG. 5 further illustrates Member 3 508 referring Candidate 3 509 for a third job listing. Candidate 3 509 is remotely connected to Member 1's 501 network 505. For example, referring to FIG. 4, Member 3 508 may be in the third level 405 of Member 1's 401 network 402. As such, if Candidate 3 509 is hired for the job listing, Member 1 501 may receive a third level incentive reward 510 because Candidate 3 509 is a remotely connected referral from Member 1's 501 network 505. As depicted in FIG. 5, the incentive reward levels are not limited to three, as other reward levels 511, 512 are possible, nor is a minimum of reward levels required as less than the number depicted in FIG. 5 may be utilized by a talent management platform according to embodiments. As depicted in FIG. 5, a member may receive a reward for a qualified referral made by themselves or anyone in their network within a certain level.

As demonstrated by the non-limiting example presented in FIG. 5, embodiments provide that a member may receive a reward for direct referrals as well as indirect referrals made by members connected with the member's network. Accordingly, members are continuously motivated to participate in the talent management platform and to increase their network in order to enhance their ability to receive rewards for qualified referrals. In addition, the tiered reward system motivates members to belong and participate over the long-term because they may receive rewards in addition to the customary one-time reward for direct qualified referrals.

Embodiments provide that a member may receive an incentive reward for a specified duration of a contract engagement, which may be the entire contract duration or some portion thereof, if the member referred the candidate hired for the engagement. The following provides a non-limiting example involving a talent management platform member who refers a candidate for a contract job listing wherein the contract of employment is for one year at a rate of $30/hour according to an embodiment. If the candidate is hired for the job listing, then the member may receive an incentive reward based on the contract rate of the job listing for a specified duration of the contract. For example, the reward may be for the entire duration of the contract or a specified portion of the contract term. For example, the incentive reward may be a percentage of the contract rate, such as 1% of the contract rate for the first six months of the contract. Thus, for the first six months of the contract, the member would be entitled to $30/hr×0.01=$3 for each hour worked by the candidate under the contract. Accordingly, embodiments provide incentives for the long-term motivation of members to belong to and participate in the talent management platform because they may receive referral rewards for a pre-determined duration of a contract worked by a candidate hired due to their qualified referral.

Embodiments are configured to provide an affinity incentive system that rewards members for activities outside of candidate referrals, such as growing the platform network or procuring job listing. According to embodiments, the talent management platform tracks certain member information, including, but not limited to, member network and social network connections, member invitations, job applications, sources of job postings, certain member outside activities, and candidate referrals. The platform may utilize the member information to provide one or more affinity incentive rewards to members. Embodiments provide that affinity incentive rewards may be directed toward member activities that provide certain benefits to the talent management platform. For example, a member may receive an affinity incentive reward for increasing the network available to the platform, such as when they invite an individual who then registers with the platform. In another example, a member may receive an affinity incentive reward for activity that promotes the platform, such as publishing an article with subject matter pertaining to the platform. In still another example, a member may be entitled to an affinity incentive reward if he procures a job listing from an employer.

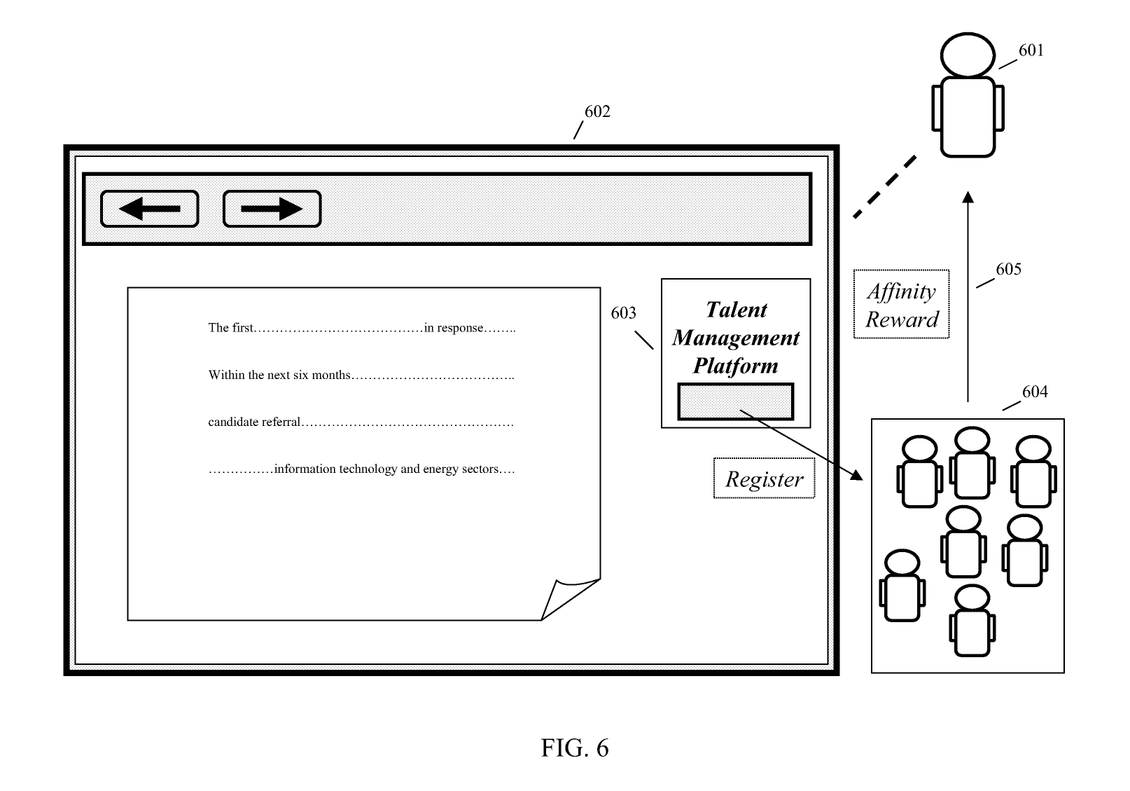

Referring to FIG. 6, therein is depicted an example of an affinity incentive reward according to an embodiment. A platform member 601 is associated with a web site 602 external to the talent management platform, such as a blog or other content sharing site. The web site 602 contains an ad 603 referring visitors to the talent management platform. The platform member 601 may receive an affinity award 605 for any members 604 who register responsive to the ad 603 on the member web site 602.

Embodiments provide for multiple incentive models for motivating members to join, maintain membership, and actively participate in a talent management platform. For example, embodiments may provide one or more referral incentives to platform members for candidate referrals to job listings or to invite members to join the platform network. In addition, embodiments provide that the referral incentives may be comprised of different reward levels, depending on the relationship between the member and the referred candidate. For example, a member may get a certain incentive for a qualified candidate referred directly by the member, and may also receive rewards for a qualified candidate referred by another member in his network. Furthermore, embodiments provide for affinity incentive rewards for members based on member activity beneficial to the talent management platform, such as increasing the networks and network connections available on the platform, and by obtaining job listings from employers.

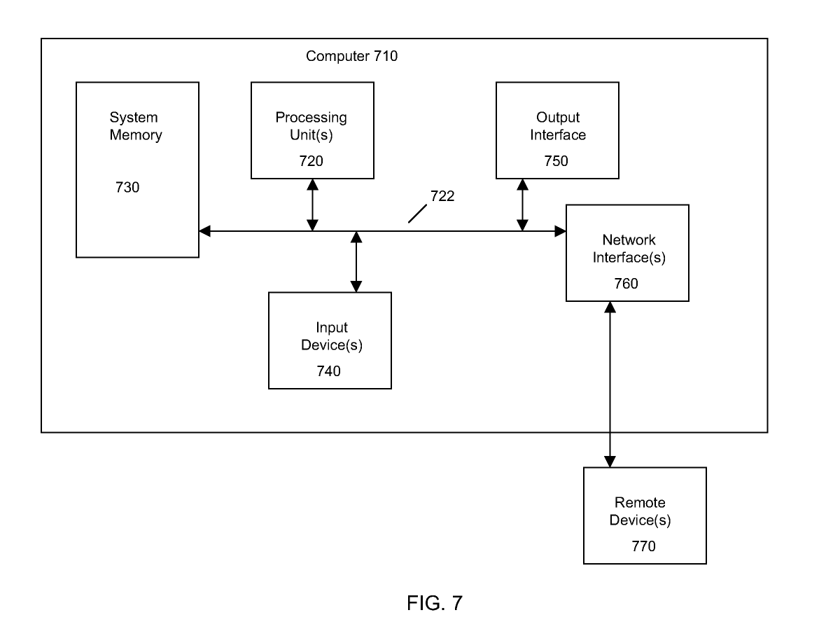

Referring to FIG. 7, it will be readily understood that certain embodiments can be implemented using any of a wide variety of devices or combinations of devices. An example device that may be used in implementing one or more embodiments includes a computing device in the form of a computer 710. In this regard, the computer 710 may execute program instructions configured to provide one or more incentive rewards to one or more members associated with one or more qualified referrals.

Components of computer 710 may include, but are not limited to, a processing unit 720, a system memory 730, and a system bus 722 that couples various system components including the system memory 730 to the processing unit 720. The computer 710 may include or have access to a variety of computer readable media. The system memory 730 may include computer readable storage media in the form of volatile and/or nonvolatile memory such as read only memory (ROM) and/or random access memory (RAM). By way of example, and not limitation, system memory 730 may also include an operating system, application programs, other program modules, and program data.

A user can interface with (for example, enter commands and information) the computer 710 through input devices 740. A monitor or other type of device can also be connected to the system bus 722 via an interface, such as an output interface 750. In addition to a monitor, computers may also include other peripheral output devices. The computer 710 may operate in a networked or distributed environment using logical connections to one or more other remote computers or databases. The logical connections may include a network, such local area network (LAN) or a wide area network (WAN), but may also include other networks/buses.

It should be noted as well that certain embodiments may be implemented as a system, method or computer program product. Accordingly, aspects may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for various aspects may be written in any combination of one or more programming languages, including an object oriented programming language such as Java™, Smalltalk, C++ or the like and conventional procedural programming languages, such as the “C” programming language or similar programming languages. The program code may execute entirely on a single computer (device), partly on a single computer, as a stand-alone software package, partly on single computer and partly on a remote computer or entirely on a remote computer or server. In the latter scenario, the remote computer may be connected to another computer through any type of network, including a local area network (LAN) or a wide area network (WAN), or the connection may be made for example through the Internet using an Internet Service Provider.

Aspects are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A system comprising:
one or more processors;
a system memory operatively coupled to the one or more processors; and
one or more professional talent management modules communicatively coupled to the system memory, wherein the one or more professional talent management modules are adapted to:
register one or more members;
list one or more positions;
accept one or more referrals for the one or more positions from the one or more members; and
provide one or more incentive rewards from a plurality of incentive reward sources to the one or more members, wherein an incentive reward source is selected according to one or more member interactions.

2. The system according to claim 1, wherein the one or more member interactions comprise being associated with a qualified referral.

3. The system according to claim 2, wherein a qualified referral comprises a referral of a candidate hired for the one or more positions.

4. The system according to claim 2, wherein the one or more referrals comprise a direct referral relative to a first member if the first member directly referred the one or more referrals for the one or more positions.

5. The system according to claim 4, wherein the one or more referrals comprise an indirect referral relative to a first member if the one or more referrals were referred by members connected to a network of the first member.

6. The system according to claim 5, wherein a value of the one or more incentive rewards is determined based on whether the one or more qualifying referrals are a direct referral or an indirect referral.

7. The system according to claim 1, further comprising:
wherein the one or more positions comprise one or more permanent positions and one or more contract positions;
wherein the one or more incentive reward sources comprise a permanent position reward source awarded for a qualified referral for the one or more permanent positions, the permanent position reward source comprising a one-time reward payment.

8. The system according to claim 7, wherein the one or more incentive reward sources comprise a contract position reward source awarded for a qualified referral for the one or more contract positions, the contract position reward source comprising one or more reward payments distributed over a specified duration of an employment contract associated with the one or more contract positions.

9. The system according to claim 1, wherein the one or more incentive reward sources comprise one or more affinity incentive rewards, the one or more affinity incentive rewards being awarded based on activity resulting in increasing a number of registered members and procurement of the one or more positions.

10. The system according to claim 8, wherein the one or more professional talent management modules are further adapted to:
arrange a member network for each of the one or more members, the member network comprising a first level, a second level, a third level, and a fourth level;
assign a member network owner to the first level;
connect one or more second level connections to the second level of the member network responsive to the one or more second level connections being invited to register or being referred for a position by the member network owner;
connect one or more third level connections to the third level of the member network responsive to the one or more third level connections being invited to register or being referred for a position by the one or more second level connections; and
connect one or more fourth level connections to the fourth level of the member network responsive to the one or more fourth level connections being invited to register or being referred for a position by the one or more third level connections;
wherein the member network owner receives a first level incentive reward responsive to making a qualified referral for the one or more positions, a second level incentive reward responsive to a second level connection receiving an incentive reward, a third level incentive reward responsive to a third level connection receiving an incentive reward, and a fourth level incentive reward responsive to a fourth level connection receiving an incentive reward;
wherein the first level incentive reward is greater than the second level incentive reward, the second level incentive reward is greater than the third level incentive reward, and the third level incentive reward is greater than the fourth level incentive reward.

11. A method comprising:
registering one or more members;
listing one or more positions;
accepting one or more referrals for the one or more positions from the one or more members; and
providing one or more incentive rewards from a plurality of incentive reward sources to the one or more members, wherein an incentive reward source is selected according to one or more member interactions.

12. The method according to claim 11, wherein the one or more member interactions comprise being associated with a qualified referral.

13. The method according to claim 12, wherein the one or more referrals comprise a direct referral relative to a first member if the first member directly referred the one or more referrals for the one or more positions.

14. The method according to claim 13, wherein the one or more referrals comprise an indirect referral relative to a first member if the one or more referrals were referred by members connected to a network of the first member.

15. The method according to claim 14, wherein a value of the one or more incentive rewards is determined based on whether the one or more qualifying referrals are a direct referral or an indirect referral.

16. The method according to claim 11, further comprising:
wherein the one or more positions comprise one or more permanent positions and one or more contract positions;
wherein the one or more incentive reward sources comprise a permanent position reward source awarded for a qualified referral for the one or more permanent positions, the permanent position reward source comprising a one-time reward payment.

17. The method according to claim 16, wherein the one or more incentive reward sources comprise a contract position reward source awarded for a qualified referral for the one or more contract positions, the contract position reward source comprising one or more reward payments distributed over a specified duration of an employment contract associated with the one or more contract positions.

18. The method according to claim 11, wherein the one or more incentive reward sources comprise one or more affinity incentive rewards.

19. The method according to claim 18, wherein the one or more affinity incentive rewards are awarded based on activity resulting in growth of the one or more networks and procurement of the one or more positions.

20. A computer program product comprising:
a computer readable storage medium having computer readable program code embodied therewith, the computer readable program code comprising:
computer readable program code configured to register one or more members;
computer readable program code configured to list one or more positions;
computer readable program code configured to accept one or more referrals for the one or more positions from the one or more members; and
computer readable program code configured to provide one or more incentive rewards from a plurality of incentive reward sources to the one or more members, wherein an incentive reward source is selected according to one or more member interactions.
